(19) United States
(12) Patent Application Publication
(10) Pub. No.: US 2010/0150182 A1
(43) Pub. Date: Jun. 17, 2010

(54) SYSTEMS AND METHODS FOR MUTIPLEXING MPEG SERVICES FOR IP NETWORKS

(75) Inventor: Ciro A. Noronha, JR., Palo Alto, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Tandberg Television Inc.

(21) Appl. No.: 12/333,440

(22) Filed: Dec. 12, 2008

(51) Int. Cl. H04J 3/02

(52) U.S. Cl. 370/537

(57) ABSTRACT

A multiplexer handling different types of traffic in different queue types, including in one embodiment time-stamped content such as in the form of MPEG service data, untimed content such as in the form of other variable bit rate data, and periodic tables, such as in the form of MPEG program specific information, allocates a tag to each packet, which is used to schedule packets for transmission. A tagging algorithm tags each packet in the queue, and a packet scheduling algorithm uses the tag to determine which packet is next to be transmitted, and a control algorithm determines when the scheduling algorithm will be executed. The algorithms cooperate to allow the multiplexer to handle traffic without requiring an internal clock to be synchronized with the input streams, nor stuffing of packets to pad out the contents of the variable bit rate traffic.

### FIELD OF INVENTION

The present invention generally pertains to multiplexers and methods for multiplexing different types of services in a multiplexer for IP networks.

### BACKGROUND OF THE INVENTION

Multiplexing of pre-encoded MPEG services into a transport stream is a very common application in communication industries. In various applications, the multiplexer is receiving feeds from one or more encoders (which can be remote from the multiplexer), and is required to produce a transport stream containing these feeds where there is no communication between the multiplexer and the encoder(s). In such cases, the presence of the multiplexer is transparent from the encoder. In other words, the encoder provides the transport stream without any communication or cooperation with an intermediate multiplexer which may be aggregating other traffic.

The simplest multiplexers receive their feeds from traditional MPEG interfaces (the most common being ASI), and provide their output on the same type of interface. The job performed by such multiplexers is simplified by the fact that the input and output interfaces deliver the content with very precise timing, with the overall output transport stream being at constant bit rate. Additionally, the output of the multiplexer is based on a constant bit rate, well timed interface. Thus, prior art multiplexers reply on, or assume, a well known or constant bit rate or clock rate.

The trend today is to replace the traditional MPEG interfaces by IP based interfaces, typically over a physical layer such as Ethernet. While this greatly facilitates connectivity among different types of interfaces, it makes the job of the multiplexer more complex, because the incoming stream now can encounter heavy jitter, which will be orders of magnitude higher than that of a traditional MPEG interface. Moreover, to make matters even more difficult, IP networks are not constant bit rate, and network operators prefer not to transmit filler packets such as NULL packets, as doing so is viewed as a waste of bandwidth. Therefore, in the general case, the incoming traffic are not only jittered, but intrinsically variable bit rate (“VBR”) in their traffic flow.

Existing IP-based multiplexers typically require either constant bit rate on the incoming streams, or a very constrained jitter, or both. In many common situations (for example, combining services from different transports which have been statistically-multiplexed), the incoming services are not constant bit rate, so the simpler multiplexers will not work. Other multiplexers can accept variable bit rate streams, but the network jitter they can accept is fairly limited, which in general cannot be guaranteed by an IP network. Finally, some multiplexers target a constant bit rate stream at their output, so they require a target rate, and will pad the resulting transport to that rate. This wastes bandwidth (padding is unnecessary in an IP network), and if the instantaneous rate of the combined services exceeds the target rate, the resulting transport will either be non-compliant, or data will be dropped.

From an algorithm implementation standpoint, these multiplexers typically require input time stamps for every service, and attempt to recover timing for each service and reference the time stamps to a local clock, and use a master clock to generate the target rate (thus having to run a phase locked loop for each incoming time base).

Thus, there is a need for multiplexers that can multiplex different types of traffic into an IP network without requiring each input stream to be time stamped, requiring a PLL, inserting NULL packets in the output stream, while maintaining packet ordering in each flow.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one embodiment of the present invention having different types of input traffic, and

FIG. 2 illustrates one embodiment of the process flow associated with the control algorithm of the present invention.

FIG. 3 illustrates one embodiment of a multiplexer executing the algorithms described herein.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

In one embodiment, an algorithm of the present invention multiplexes one or more input flows composed of transport packets, into one single output flow of transport packets. The packets being multiplexed are not changed in any way, and no additional or extra packets are generated by the algorithm. Further, the respective order of the packets in a queue is preserved. The algorithm supports three types of input flows, which encompasses all the possible data flows in a traditional MPEG transport stream. These are:

(1) Time-Related Content. This type of content are packets that contains time-related data which can be embodied in the form of Program Clock References (“PCRs”) used in MPEG traffic. The time-related content is in the form of a number representing “ticks” of a 27 MHz clock. Other embodiments could use time-related data in other formats or structure, such as a time stamp. The content of this type traffic may contain one or more services (i.e., one or more unrelated PCR flows). This content is composed of one or more packet identifiers (“PIDs”) that are pre-multiplexed and must stay in the same order. Examples would be a single program transport stream (“SPTS”) with one video PID and one or more audio PIDs, or a multiple program transport stream (“MPTS”) conveying multiple services.

(2) Untimed Content. This type of content does not include any sort of timing information (i.e., pure data). This could include asynchronous or variable bite rate data streams. One example would be IP packets carried over transport packets using multi-protocol encapsulation (“MPE”). For the purposes of the multiplexer, each untimed content queue has a configured maximum data rate, which can be defined by a system administrator or otherwise configured in the multiplexer.

(3) Periodic Table Content. This type of content would include traditional MPEG program specific information such as the Program Association Table (“PAT”) and the Program Map Table (“PMT”) as well as digital video broadcasting (“DVB”) tables such as the Service Description Table (“SDT”), the Network Information Table (“NIT”) and others. These periodic tables are transmitted repeatedly at constant intervals, and thus can be viewed as periodic.

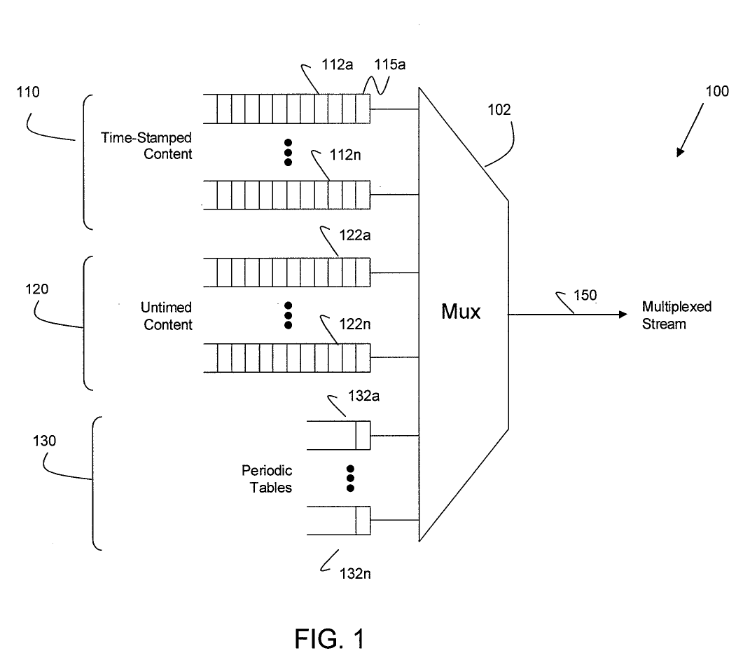

These types of traffic are illustrated in FIG. 1. In FIG. 1, the system 100 comprises a multiplexer 102 implementing the algorithm of the present invention, which receives a number of input queues 112, 122, and 132, which are multiplexed onto a single output 150. The inputs may be generated from various and different sources, such as MPEG encoders, IP gateways, etc. (not shown), and there is no communication presumed between the multiplexer 102 and the source. Multiple transport packet flows of each of the types described above are received and queued, and the multiplexer decides in which order they are transmitted. Specifically, in FIG. 1 there is a queue for time-related content 110 which comprises n separate queues 112a-112n. This could correspond to the above described MPEG programming. Each queue may comprise a number of individual packets. Thus, for example, packet 115a in queue 112a is the first packet in the queue, followed by others. These queues are first-in first-out queues.

Next, there are a series of queues for untimed content 120. Again, there can be n queues 122a-122n, and the number n is not required to be the same as for the time-stamped content queues. Thus, the value of n merely indicates a variable number.

Finally, there is also a set 130 of periodic table queues 132a-132n. As with the other queues, each queue 132a-132n includes one or more packets representing the above mentioned periodic tables.

The structure shown in FIG. 1 is merely illustrative. As discussed below, it is possible that not all types of queues are present, nor is it required that any given queue have packets waiting for multiplexing. However, in at least applications involving multiplexing of MPEG traffic, the time-related queues are present. It is possible that a queue may have only one or no packets therein. Further, although the present invention is described in terms of certain types of traffic (e.g., “periodic table” type of traffic), there is no requirement that the data content of the packets contain the aforementioned data.

From a high-level point of view, each of the data flows at the input to the multiplexer goes to a separate queue. Packets stay in this queue until the algorithm decides the packet should be transmitted. For the purposes of this discussion, the overall multiplexing algorithm can be divided into the following parts:

(1) Packet scheduling algorithm. The packet scheduling algorithm decides which packet will be the next to be transmitted on the multiplexer output.

(2) Tagging algorithm. The tagging algorithm inspects the queues and associates a tag to each packet. This tag will be used for scheduling transmission of that packet.

(3) Control algorithm. The control algorithm decides when to start and when to stop the packet scheduling algorithm based on the state of the queues. Recall that the packet scheduling algorithm decides which packet to transmit next, hence the control algorithm controls when packets are transmitted.

### Packet Scheduling Algorithm

The packet scheduling algorithm assumes that, associated with each packet, there is a tag containing one non-negative number (e.g., 0 and up) that represents the gap between that packet and the packet that precedes in the queue. In other words, a packet's tag is a number that is proportional to the ideal inter-packet gap between the packet and the one sent before it. It is possible that some packets in a queue will have the same tag value (e.g., packets in the time-related content queue). The algorithm is not dependent on, nor requires any particular scale or units of the tag number, or how it relates to time. All the algorithm needs to know is that the packets will be scheduled at a rate inversely proportional to the tag value. For example, if the tags for all packets in queue A have a value of X, and the tags for all packets in queue B have a value of 2×, the algorithm will schedule two packets from queue A for each packet of queue B.

Formally, assuming that there are N queues being served by the packet scheduling algorithm (which includes all of the different queue types), and Tᵢ is the tag associated with the packet at the head of queue i, i=1, . . . , N, the scheduling algorithm will pick packet j for transmission such that:

$${T}_{j} = {min}_{i} ( {T}_{i} ) , i = 1 , … N \qquad [ 1 ]$$

After the packet at the head of the queue j is transmitted (also referred to as the initial packet), the tags for the remaining queues are updated by subtracting Tⱼ from each of them; the tag for queue j will be that of the next packet in that queue. Formally:

Tᵢ←Tᵢ−Tⱼ,i=1, . . . N,i≠j [2]

Essentially, this algorithm works in the same fashion as an event-driven simulation: an event happens (the transmission of a packet), and then the “simulation clock” advances to the next event (decrementing the tag is equivalent of incrementing a clock, even though there is no “master clock” value).

It is possible that a packet at a head of a queue has the same tag value as another packet at the head of another queue. In such a situation, the algorithm can arbitrarily pick one over the other, but nevertheless, both packets will be multiplexed together.

### Tagging Algorithm

The tagging algorithm is responsible for associating the tags with the packets. The details on how this happens are a function of the type of queue, as previously described (e.g., time-related queues, untimed content queues, and periodic table queues). The specific methods are described below.

The tagging algorithm is aware of the relationship between the tag value and actual inter-packet time. Recall that there is a maximum bit rate associated with the untimed content queues, and there is a desired repetition rate for the periodic table queues. Since the time-related content is a transport stream whose time-related data are PCRs, and since PCRs in MPEG are expressed as a number of clock counts at 27 MHz, this implementation of the algorithm assumes that the tags are expressed in clock ticks at 27 MHz.

The tags for time-stamped content are created based on the PCR time-related data which are present in the MPEG packets. In summary, for each queue, the time-related content packets needs to be buffered until a pair of PCRs are received. If the content contains multiple PCR flows, one of the flows will be arbitrarily selected for this purpose. If Pᵢ is the value of the first PCR, and Pᵢ₊₁ is the value second PCR, and there are n transport packets between Pᵢ and Pᵢ₊₁ (including Pᵢ but not Pᵢ₊₁) the tag given to each of these n packets will be:

$$tag = \frac{{P}_{i + 1} - {P}_{i}}{n} \qquad [ 3 ]$$

Thus, the time-related packets between the two PCR values (as well as the packet containing the initial PCR value) will have the same tag value. From an implementation point of view, the tag number used by the algorithm can be a fraction or a floating point number. However, since the tag is expressed in 27 MHz clock ticks (corresponding to a precision of approximately 37 ns per tick), the algorithm can also truncate or round the result of equation [3] with negligible loss of precision.

As for creating tags for the untimed content queue, each untimed content queue will have a configurable maximum data rate. This could be set by the user, or an administrator, or by other means. The tag value will be constant for all the packets in a given queue, and will simply reflect the configured rate of that queue, expressed in 27 MHz ticks for the transmission of each transport packet. For example, if the configured rate for give untimed content queue is R bits/sec, then the tag value will be given by:

$$tag = \frac{188 \times 8}{R} \times 27 \text{,} 000 \text{,} 000 \qquad [ 4 ]$$

This is based on the MPEG standard having 188 byte transport packets, wherein each byte is 8 bits long.

The algorithm for associating tags to packets in this queue is as follows:
The tag for the very first packet added to the queue is set to zero (immediate transmission).
The tag given to the subsequent packets is decided as follows:
   If the queue is not empty when the packet is added to it, the packet will get the tag given by equation [4] above.
   If the last packet of the queue is transmitted, the tag given by equation

[4] is given to the head of the queue (which is empty), and is decremented as given by equation [2] as the scheduling algorithm runs. If a packet is added to the queue at a later time, it will take this head-of-the-queue tag. Note that if this tag gets to zero, it must stay at zero (e.g., it is never negative in value), and the next packet will be immediately scheduled when it shows up.

As for creating tags for periodic table packets, recall that these are repeated periodically in typical MPEG applications. The periodic table queue will typically have only one packet present at a time; once that packet is transmitted, a new copy of the same packet is immediately put in the queue, with the proper tag assigned. The tag will simply reflect the repetition rate of the table. For periodic tables such as PAT and PMT, the interval between instances is required to be 100 milliseconds (i.e., 10 times per second). Other periodic tables may be sent at different intervals. The tag will correspond to the periodic table interval, expressed in 27 MHz ticks. In other words, if the periodic table repetition interval is T seconds, the tag for that table queue is given by:

tag=T×27,000,000

### Control Algorithm

Each loop of the scheduling algorithm selects a packet for transmission and de-queues it from its respective queue. The control algorithm decides when to run the scheduling algorithm, and when to stop it. From a process point of view, the control algorithm can be considered as being invoked every time a packet is added to any of the queues. It then inspects the state of the queues, and decides to run the scheduling algorithm zero or more times. Alternatively, the control algorithm can be viewed as continuously running, and executing the scheduling algorithm portion when necessary, such as when every time a packet is added to any of the queues.

A queue is considered to be “ready” when it is non-empty and the packet at its head has a tag. Periodic table queues are always ready because they always have a packet to transmit, and the tag is always known. Untimed content queues are ready when they are non-empty, since their tag is also always known.

With this definition, the control algorithm is running the scheduling algorithm as long as all the time-related content queues are ready. Once any one of the time-related content queues becomes non-ready (because, for example, it has not yet received the next PCR packet), the control algorithm stops. For every packet added to any queue, the control algorithm will check again if all the time-related content queues are ready; when that happens, the control algorithm will run the scheduling algorithm again.

From a practical implementation point of view, the control algorithm also needs to consider the case where the feed for a time-related content queue disappears. Various conditions outside the scope of the multiplexer may cause the data provided to an input queue to be terminated (e.g., an MPEG encoder fails, and thus no time related content is provided to the multiplexer). The control algorithm is able to decide to remove such a queue from scheduling; or, more specifically, various criteria can be defined as to how long to wait for the time-related queue(s) to become ready.

DVB compliance requires a PCR interval under 40 milliseconds. If a time-related queue stops receiving packets, and thus causes the control algorithm to wait, over time the other time-related queues will grow. Recall that the control algorithm runs when all time-related queues are ready. Therefore, the criteria for deciding to drop a queue will be driven by the current size of the other queues. In order to avoid queue deletion due to just network jitter, it is necessary to have a safety factor. In one embodiment, this safety factor is selected to be twice the DVB-required interval, namely 80 milliseconds. However, this is not directly measured in absolute time. Rather, this criterion for deleting a time-related queue is done when all the other queues have accumulated bitstream equivalent to 80 milliseconds of transmission. More specifically, when the difference between the oldest PCR in each queue and the newest PCR in each queue exceeds 80 milliseconds (in 27 MHz ticks-2,160,000 ticks), then the offending queue can be removed from processing.

Another anomaly case that needs to be considered is what to do if there are no time-related queues. In this case, untimed packets are scheduled as indicated above as they become available. If there are no untimed packets available, then nothing is scheduled or transmitted, because there is no point in scheduling tables if there is no content to transmit.

Yet another case is when there is a mixture of time-related and untimed queues, and the traffic on all time-related queues stops for some reason. At this point, there is no time reference to the algorithm. One possible embodiment is to define a maximum size for the untimed queues and delete the remaining time-related queues when these overflow. Another approach would be to simply stop and wait (possibly for an undetermined amount of time) until the time-related traffic resumes.

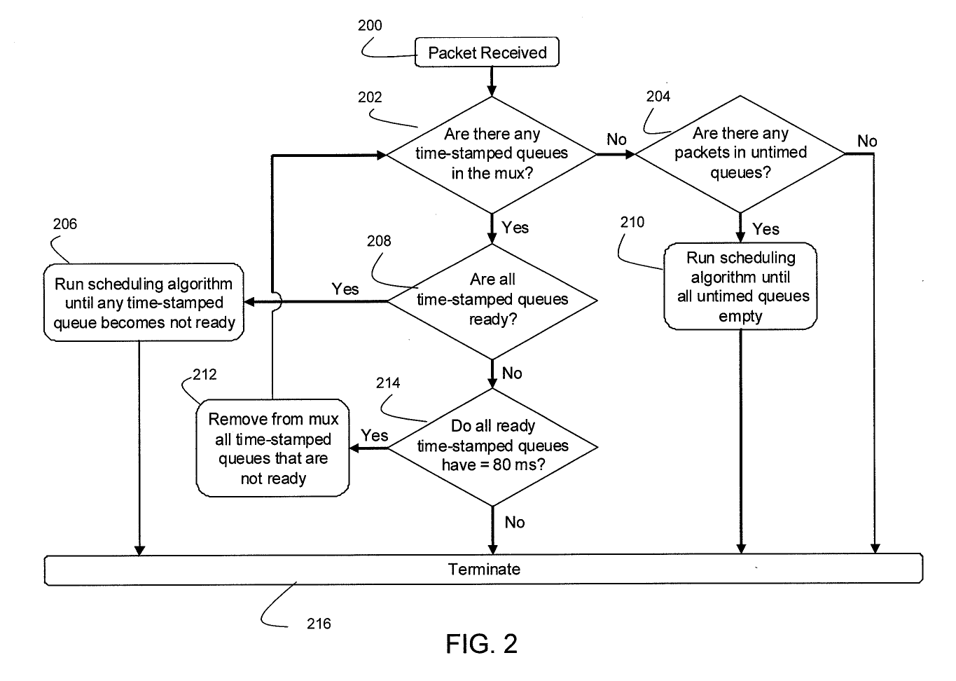

One embodiment of the control algorithm is illustrated in FIG. 2. This embodiment does not illustrate all the possible error handing possibilities. In this version, the process begins in step 200, when a packet is received. The process checks in step 202 whether there are any time-related queues present, and if the result is “no”, then the process continues to step 204 which checks whether there are any packets present in the untimed queues. If not, the process proceeds to step 216, where it terminates; it does not need to check the periodic table queues because, as indicated above, there is no point in sending periodic table packets without any other content. Note that normally, periodic table packets are present in the multiplexer whenever there are any time-related contents packets, but this is not always required. It is possible to have time-related content packets but not the periodic table packets. However, the reverse is not true, namely, if periodic table packets are present, then there typically are time-relateded packets present. If however, there are packets in the untimed queues or in the time-relateded contents queues, then the scheduling algorithm is executed in step 210.

If there are time-related content queues in step 202, then the control algorithm in step 208 checks if all the time-related queues are ready. If yes, then the process continues in step 206 which runs the scheduling algorithm until not all the time-related content queues are ready. If the time-related contents queues in step 208 are not all ready, then there is a test in step 214 to see whether one or more time-related queues have encountered an error condition. Thus, if all the other (ready) time-related queues have accumulated a bitstream of 80 milliseconds or more, then the non-ready queues are removed from consideration in step 212, and the process repeats to step 202. Otherwise, the process at step 214 continues to step 216, which terminates the process until another packet has been received.

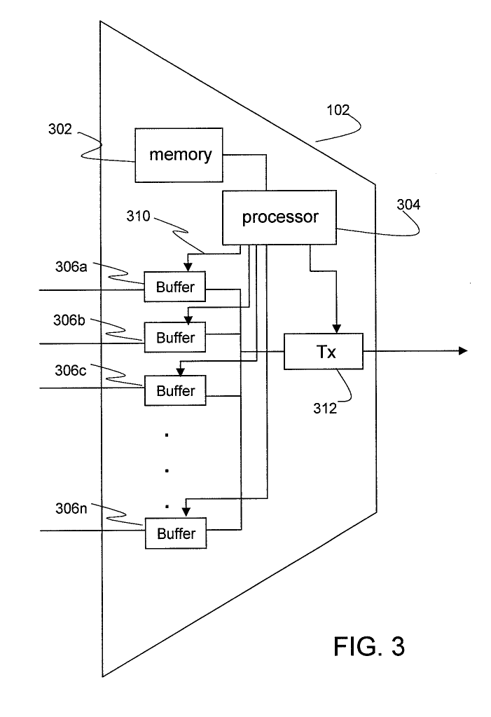

The above algorithms, the packet scheduling algorithm, the tagging algorithm, and the control algorithm, can be implemented as software modules executing in a multiplexer. One embodiment is shown in FIG. 3. In FIG. 3, the multiplexer 102 is shown as having a processor 304 connected to a memory 302. The memory would store the modules and the processor would execute each as necessary and described above. The processor would also have the ability to communicate with a plurality of buffers 306a-306n via signaling links 310 (of which only one is shown) and to the transmitter 312. In this manner, the processor is able to execute the modules, monitor the status of the buffers (including receiving notification when a packet arrives). The tag values can be stored in memory 302, or in another memory (such as in a fixed location in each buffer). Those skilled in the art will recognized that the algorithms can also be defined in hardware, as an ASIC or PLA, and that the same algorithms can be executed.

That which is Claimed:

1. A method for scheduling packets into a single output flow at a multiplexer, comprising the steps of:
receiving a plurality of time-related content packets at said multiplexer wherein some but not all packets comprise respective time-related data;
storing said plurality of time-related content packets in a plurality of buffers wherein all packets in a respective buffer are associated with each other as a single input flow;
determining for each input flow in a respective buffer that said plurality of time-related content packets comprises at least a first and a second packet respectively indicating time-related data;
generating a respective tag for said time-related content packets in each of the plurality of buffers wherein each said respective tag is associated with a respective packet, wherein each of said packets between said first and second packet indicating time related data in a single buffer have the same tag value;
initiating a scheduling module wherein the scheduling module performs the steps of analyzing each respective tag for each respective packet at a head of each respective buffer;
selecting an initial packet from among one of the buffers wherein said initial packet with a lowest tag value;
transmitting said packet associated with said lowest tag value; and
updating each of said remaining tags in each buffer wherein a value of each of said remaining tags is reduced in value by the lowest tag value.

2. The method of claim 1 further comprising the steps of:
receiving one or more periodic table content packets at said multiplexer, wherein said periodic table content packets comprise periodic table data associated with said plurality of time-content packets;
storing said one or more periodic table content packets in a second buffer; and
allocating one or more tag values respectively to said one or more periodic table content packets, wherein
the step of selecting a packet from one of the buffers having a lowest tag value comprises selecting a packet from one of the buffers including said second buffer having a lowest tag value.

3. The method of claim 2 wherein the tag value for said one or more periodic table content packets is determined by the formula: tag value=T*27,000,000, where T is a periodic table repetition interval in seconds of time.

4. The method of claim 3 wherein the periodic table content packets comprise one or more of MPEG Program Specific Information data or DVB System Information data, and wherein said time-related data comprises MPEG Program Clock References.

5. The method of claim 1 wherein the tag value for said time-related content packets is based on the formula of: tag value=(Pᵢ₊₁−Pᵢ)/n wherein Pᵢ₊₁ is the time-related value indicated in packet Pᵢ₊₁, Pᵢ is the time-related value in packet Pᵢ, and n is the number of packets between Pᵢ₊₁ and Pᵢ, including Pᵢ, but not Pᵢ₊₁.

6. The method of claim 2 further comprising the steps of:
receiving one or more untimed-content packets at said multiplexer;
storing said one or more untimed-content packets in a third buffer; and
allocating one or more tag values respectively to said one or more untimed-content packets, wherein
the step of selecting one of said a packet from one of the buffers having a lowest tag value comprises selecting an initial packet having a lowest tag value from one of the buffers including said second and third buffers.

7. The method of claim 1 wherein the step of initiating the scheduling module is initiated upon detection of an incoming packet to the multiplexer.

8. A method for controlling a scheduling of traffic in a multiplexer comprising the steps of:
receiving a first plurality of time-related content packets associated with a single transport stream, a subset of said first plurality of packets comprising time-related content comprising a MPEG program clock reference (PCR) data;
storing said first plurality of time-related content packets in a first buffer;
receiving a second plurality of untimed content packets at said multiplexer;
storing said second plurality of untimed content packets in a second buffer;
receiving a third plurality of periodic table content packets at said multiplexer;
storing said third plurality of packets in a third buffer;
executing a scheduling module wherein said scheduling module performs the steps of:
determining that said first plurality of packets in said first buffer comprise a first PCR data and a second PCR data;
allocating a respective tag value to each of the first plurality of time-related content packets, the second plurality of untimed content packets, and said third plurality of periodic table content packets;
selecting a tag having the lowest value from a respective initial packet from the first buffer, the second buffer, and the third buffer;
transmitting a packet associated with said tag having the lowest value, wherein said packet at the head of its respective buffer;
updating each remaining respective tag associated with each remaining respective packet of said first, second, and third buffers.

9. The method of claim 8 wherein the step of
determining that said first plurality of packets in said first buffer comprise a first PCR data and a second PCR data,
comprises the step of
determining that said first plurality of packets in said first buffer comprise a first PCR data and a second PCR data, and a fourth plurality of packets in a fourth buffer comprising time-related content packets comprises a third PCR data and a fourth PCR data.

10. The method of claim 8 wherein the tag value allocated to said second plurality of untimed content packets is determined by the formula: tag value=(188*8)/R*27,000,000 wherein R is the configured transmission rate in bits/second for untimed content data in the second buffer.

11. The method of claim 8 wherein the tag value allocated to said third plurality of periodic table content packets is determined by the formula: tag value=T*27,000,000 wherein T is a periodic table repetition rate.

12. The method of claim 8 wherein the step of executing a scheduling module is initiated by detection of an incoming a packet.

13. A system for multiplexing time-related content packets, periodic table content packets, and untimed content packets, comprising:
a first buffer for storing time-related content packets comprising MPEG data, a first time-related content packet comprising a first program clock reference (PCR), and a second time-related content packet comprising a second program clock reference;
a second buffer storing untimed content packets;
a third buffer storing periodic table content packets, wherein said periodic table content packets convey one or more of either MPEG Program Specific Information (PSI) data or DVB System Information data;
a memory for storing a plurality of tag values, said memory further storing a scheduling module for selecting a packet for transmission stored in one of said first buffer, said second buffer, or said third buffer;
a processor configured to detect an incoming packet to said one of said first buffer, said second buffer, or said third buffer, and executing said scheduling module in response to detecting said incoming packet.

14. The system of claim 13 wherein said processor is configured to determine that said first buffer comprises said first time-related content packet comprising said first program clock reference (PCR) and said second time-related content packet comprising said second program clock reference prior to executing said scheduling module.

15. The system of claim 13 wherein said processor is configured to determine prior to executing said scheduling module a fourth buffer comprising further time-related content packets comprises a third time-related content packet comprising a third program clock reference (PCR), and a fourth time-related content packet comprising a fourth program clock reference.

16. The system of claim 13 wherein the scheduling module comprises instructions to configure the processor to select said packet for transmission based on a respective tag value, wherein said respective tag value is not higher in value than any other tag value.

17. The system of claim 13 wherein the processor is configured to update a respective value of the plurality of tag values stored in memory after transmitting the packet stored in one of said first buffer, said second buffer, or said third buffer.

18. The system of claim 17 wherein the processor is configured to update the value of the respective plurality of tag values stored in memory by reducing the respective value by an amount corresponding to a tag value of the transmitted packet.

19. The system of claim 13 wherein the processor is configured to remove packets from a fourth buffer comprising time-related content packets upon detecting said first buffer further comprising a third time-related content packet comprising a third program clock reference.

20. The system of claim 13 wherein said processor is configure to repeat execution of said scheduling module until said first buffer becomes not ready.
